(19) United States
(12) Patent Application Publication
(10) Pub. No.: US 2025/0124308 A1
(43) Pub. Date: Apr. 17, 2025

(54) METHOD AND SYSTEM FOR INTERACTIVE VISUALIZATION OF LARGE LANGUAGE MODEL DESIGN KNOWLEDGE

(71) Applicants: Purdue Research Foundation, West Lafayette, IN (US); Massachusetts Institute of Technology, Cambridge, MA (US)

(72) Inventors: Karthik Ramani, West Lafayette, IN (US); Runlin Duan, West Lafayette, IN (US); Maria Yang, Cambridge, MA (US)

(21) Appl. No.: 18/913,541

(22) Filed: Oct. 11, 2024

Related U.S. Application Data
(60) Provisional application No. 63/543,933, filed on Oct. 13, 2023.

(51) Int. Cl. G06N 5/022

(52) U.S. Cl. CPC G06N 5/022

(57) ABSTRACT

A system and method for interactive visualization of knowledge provided by large language models (LLMs) is disclosed. The system advantageously organizes LLM responses into an interactive knowledge graph visualization. Additionally, the system enables the user to interactively expand a knowledge graph by further prompting the LLM to provide additional responses that include additional knowledge. When applied to the task of design ideation, the interactive knowledge graph visualization helps to mitigate design fixation and enhances the overall efficiency, quality, quantity, and depth of concepts in the ideation process.

This application claims the benefit of priority of U.S. provisional application Ser. No. 63/543,933, filed on Oct. 13, 2023 the disclosure of which is herein incorporated by reference in its entirety.

### FIELD

The devices and methods disclosed in this document relate to data visualization and, more particularly, to interactive visualization of large language model design knowledge.

### BACKGROUND

Unless otherwise indicated herein, the materials described in this section are not admitted to be the prior art by inclusion in this section.

Idea generation is a pivotal phase in the design process, introducing concepts for subsequent development, modeling, and manufacturing. Two common challenges in achieving high-quality design ideation are: first, exploring the design space in a breadth-first manner to generate as many design concepts as possible, and second, delving into the potential of these concepts in depth to fully uncover their capabilities. To overcome these challenges, textual stimuli have been widely used to provide designers with concepts and information related to their original thinking. Textual stimuli can involve design datasets consisting of existing designs and ideas to query and retrieve design information for inspiration. Knowledge graph-based datasets have been created to fulfill this requirement.

Recent advances in Generative Artificial Intelligence (GAI) and Large Language Models (LLMs) have opened up new possibilities to enhance human design capabilities by integrating diverse knowledge elements into cohesive patterns. This allows for critical thinking and learning through the formation of concept connections and divergent investigations. LLMs are a type of GAI that generates textual responses based on given input contexts. They are commonly used for language-related tasks, such as translation, answering questions, and text comprehension. Recently, LLMs have gained attention from the design community for their potential to support text stimuli in design ideation. Unlike previous creative design tools that retrieve information from explicit knowledge datasets, LLMs can infer implicit information from generative pre-training and possess contextual understanding, enabling them to generate creative and context-relevant responses for multiple design tasks.

However, the challenge of effectively managing and leveraging the overwhelming volume of textual responses from LLMs can hinder efficient collaboration with LLMs in design ideation. To improve this collaboration, a system is needed to address the current inefficiencies in the interaction between humans and LLMs during the design process.

### SUMMARY

A method for visualizing natural language response of a language model is disclosed. The method comprises displaying, on a display, a graphical user interface. The method further comprises generating, with a processor, a first natural language prompt based on first user inputs received via the graphical user interface. The method further comprises receiving, with the processor, a first natural language response from the language model that is responsive to the first natural language prompt. The method further comprises generating, with the processor, a knowledge graph representing the first natural language response. The method further comprises displaying, on the display, a graphical representation of the knowledge graph in the graphical user interface.

### BRIEF DESCRIPTION OF THE DRAWINGS

The foregoing aspects and other features of the system and method are explained in the following description, taken in connection with the accompanying drawings.

FIG. 1 shows an exemplary embodiment of the interactive knowledge visualization system.

FIG. 2 shows a logical flow diagram for a method for visualizing knowledge of an LLM using a knowledge graph.

FIG. 3 shows a logical flow diagram for a method for interactively expanding the knowledge graph to include further knowledge of the LLM.

FIG. 4A shows an exemplary graphical user interface of a sidebar menu for generating a natural language prompt.

FIG. 4B shows an exemplary visualization of a knowledge graph.

FIG. 4C shows a further exemplary graphical user interface of the sidebar menu for exploring the natural language prompts and responses of the LLM.

FIG. 4D shows an exemplary graphical user interface of an interaction menu for interacting with nodes of the knowledge graph and generating further natural language prompts.

FIG. 5 summarizes exemplary natural language prompt templates for the task of design ideation.

FIG. 6 shows pseudocode for generating a natural language prompt for an LLM.

FIG. 7 shows pseudocode for generating a knowledge graph based on a natural language response from an LLM.

FIG. 8A illustrates a first exemplary use case in which a user generates design concepts and visualizes them structurally.

FIG. 8B illustrates a second exemplary use case in which the user explores a functional decomposition of a concept.

FIG. 8C illustrates a third exemplary use case in which a user compares two design concepts.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

Large Language Models (LLMs) open up myriad possibilities for augmenting the idea-generation processes of human designers. However, how human designers can best work with such models is less well understood, and the ideas generated by LLMs are often found to be redundant and fragmented. To address this, an interactive knowledge visualization system 100 is introduced that enables structured human-AI collaborative design ideation. Particularly, the interactive knowledge visualization system 100 advantageously organizes LLM responses into an interactive knowledge graph visualization. The interactive knowledge visualization system 100 advantageously provides a well-organized framework that empowers users to manage the knowledge provided by the LLM, with the aid of a visual interface. Moreover, the interactive knowledge visualization system 100 mitigates design fixation and enhances the overall efficiency, quality, quantity, and depth of concepts in the ideation process with the aid of this symbiotic human-LLM visual interface. Thus, the interactive knowledge visualization system 100 enhances overall efficiency and quality in the ideation process.

The interactive knowledge visualization system 100 provides graphical user interfaces to facilitate efficient exploration of LLM-generated knowledge through interactive visualization. Thus, the graphical user interface supports human-AI collaborative ideation through the interactive visualization of LLM-generated design knowledge.

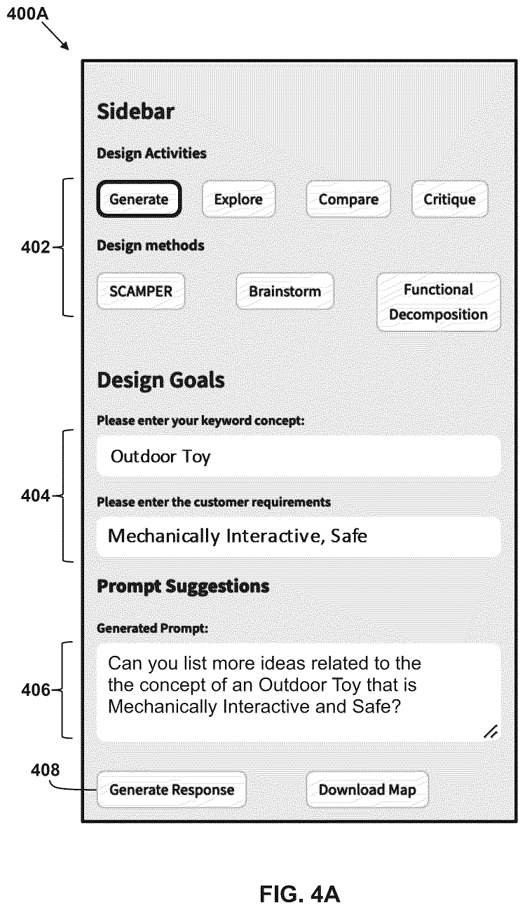

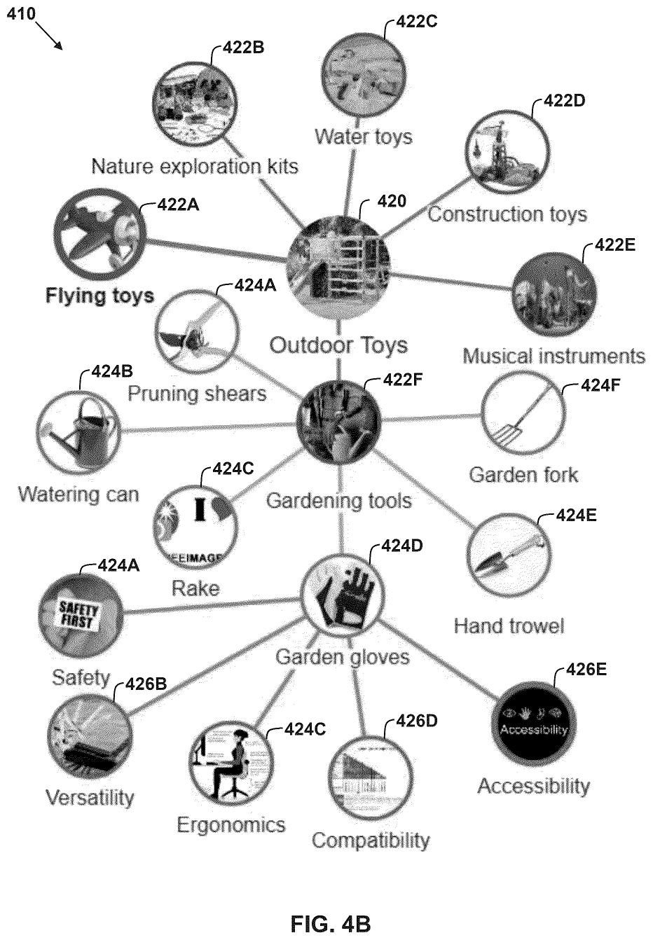

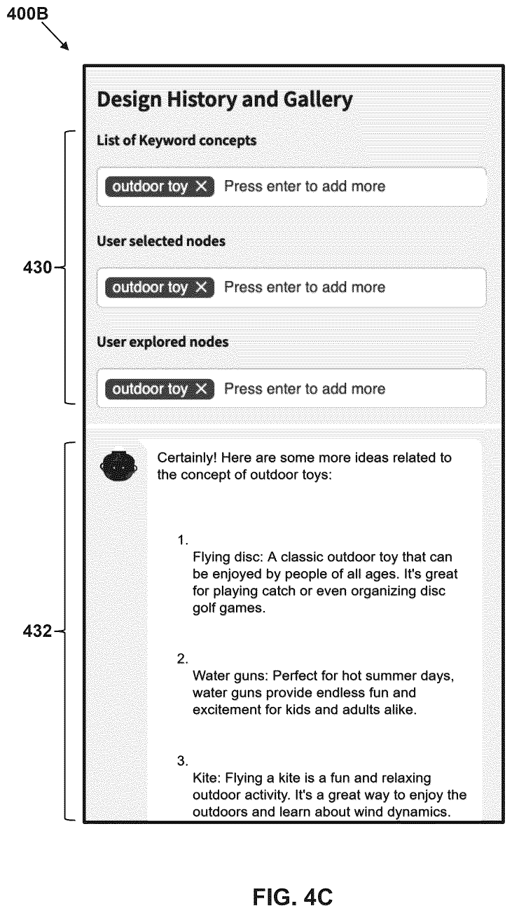

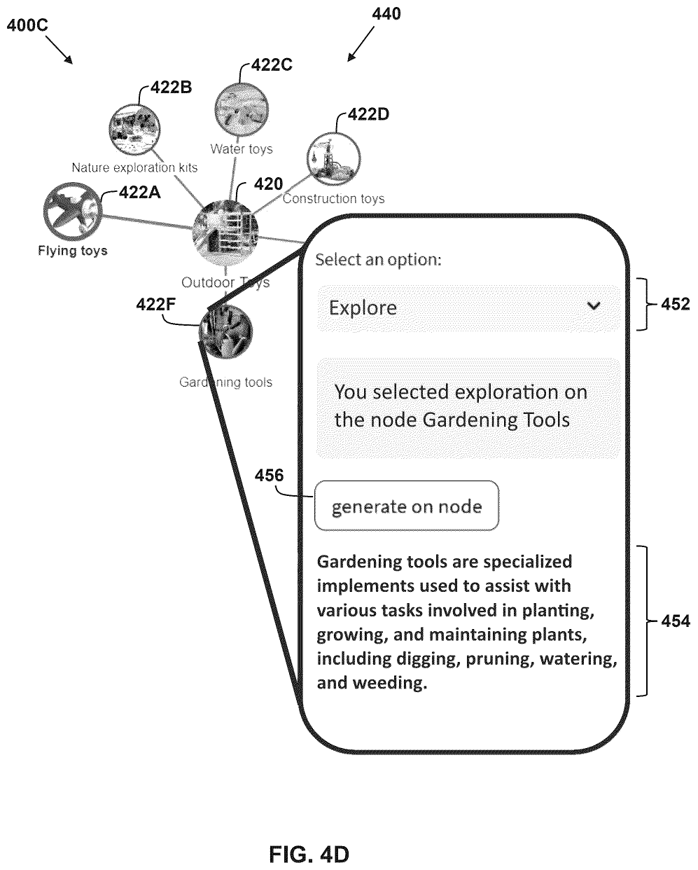

With reference to FIG. 4A, a sidebar menu enables the user to provide text inputs including keywords or key phrases indicating the LLM-generated knowledge that they would like to explore (e.g., identifying a design goal that the user would like to achieve during an ideation process), as well as keywords or key phrases indicating constraints or requirements (e.g., design constraints or design requirements on the user's design goal). Additionally, the sidebar menu enables the user to select one or more options that specify a particular approach, methodology, or activity that indicate a manner in which the user would like to explore the LLM-generated knowledge or indicate a goal of the user in exploring the LLM-generated knowledge (e.g., selecting a design activity to be performed or selecting a design method to be used).

Based on the text inputs and option selections received from the user via the sidebar menu, the interactive knowledge visualization system 100 generates a natural language prompt for an LLM 150 to generate a response that includes knowledge regarding the provided keywords or key phrases. The interactive knowledge visualization system 100 generates an initial suggestion of a natural language prompt based on the keywords or key phrases input by the user and any other text inputs or selected options in the sidebar menu. The interactive knowledge visualization system 100 incorporates a comprehensive prompt library. The prompt library includes prompts associated with specific design activities, including concept generation, exploration, comparison, and critiquing. Additionally, the prompt library includes prompts associated with specific design methods, including SCAMPER (“Substitute, Combine, Adjust, Modify, Put to other uses, Eliminate, Reverse”), brainstorming, and functional decomposition.

After the interactive knowledge visualization system 100 generates a suggested natural language prompt, the user can edit and revise the prompt until they are satisfied. With reference to FIG. 4C, the interactive knowledge visualization system 100 also tracks the keywords and phrases (i.e., concepts) that the user prefers and displays them in a design gallery for further refinement and reuse. The textual response history from the LLM 150 is also available for the user's reference.

Once the user has finalized their initial natural language prompt, the prompt is provided to the LLM 150 to generate a natural language response. The interactive knowledge visualization system 100 processes the natural language response to generate a knowledge graph representing the information contained therein. Moreover, the interactive knowledge visualization system 100 displays an interactive visualization of the knowledge graph within a knowledge graph canvas of the graphical user interface.

This knowledge graph structure serves as a visual representation of the design knowledge collaboratively generated by both the human designer and the LLM 150. In some embodiments, the knowledge graph is structured around three distinct types of nodes, including concept nodes, information nodes, and example nodes, thereby enhancing visualization, understanding, and interaction. The generated knowledge graph helps users initiate subsequent ideation iterations, leading to the refinement of concepts until the most preferred concept is obtained. Additionally, structuring the design concepts with a knowledge graph prevents users from being overwhelmed by extensive LLM responses.

With reference to FIG. 4B, the knowledge graph may be visualized as a node-link diagram, in which entities are represented as nodes and relationships are represented as edges connecting the nodes in a web-like manner. In some embodiments, different types of nodes are rendered in a visually distinctive manner, for example with different color-coding. Additionally, in some embodiments, representative images for each node are retrieved and displayed within the visualization. However, it should be appreciated that the knowledge graph can be visualized in a wide variety of ways.

The interactive knowledge visualization system 100 supports direct interaction with the knowledge graph through an interaction menu. With reference to FIG. 4D, the interaction menu enables the user to directly modify the knowledge graph, as well as generate new natural language prompts that are used to expand the knowledge graph with additional knowledge from the LLM 150. Particularly, the user selects a node in the knowledge graph to view the interaction menu. Information associated with the node is provided to the user for reference. From the interaction menu, the user can select an option to generate a new natural language prompt based on the information of the selected node. The new prompt is provided to the LLM 150 to generate an additional natural language response. The interactive knowledge visualization system 100 processes the additional natural language response to expand the knowledge graph to further represent the information in the additional natural language response. In this way, the interactive knowledge visualization system 100 advantageously enables the user to iteratively expand upon the knowledge graph as they explore the knowledge provided by the LLM 150.

### Exemplary Hardware Embodiment

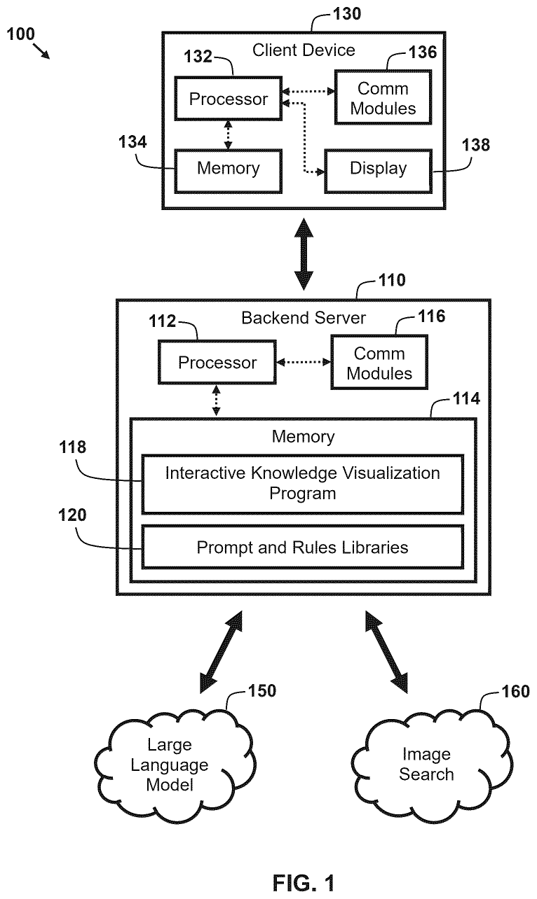

FIG. 1 shows an exemplary embodiment of the interactive knowledge visualization system 100. In the illustrated embodiment, the interactive knowledge visualization system 100 includes a backend server 110 and one or more client devices 130. Each client device 130 is configured to enable a user to interact with an application or web-interface that communicates with the backend server 110 to generate natural language prompts for a large language model (LLM) 150. The backend server 110 is configured to provide the natural language prompt to the LLM 150. The backend server 110 processes the natural language response from the LLM 150 to generate a knowledge graph representing the information contained in the natural language response. Additionally, the backend server 110 generates a visualization of the knowledge graph, which may include retrieving representative images using an image search platform 160. The knowledge graph and/or the generated visualization is transmitted back to the client device 130 and displayed to the user.

The backend server 110 may include one or more servers configured to serve a variety of functions for the interactive knowledge visualization system 100, including web servers or application servers depending on the features provided by the interactive knowledge visualization system 100. Each backend server 110 includes, for example, a processor 112, a memory 114, and a network communications module 116. It will be appreciated that the illustrated embodiment of the backend server 110 is only one exemplary embodiment of a backend server 110 and is merely representative of any of various manners or configurations of a personal computer, server, or any other data processing system that is operative in the manner set forth herein.

The processor 112 is configured to execute instructions to operate the backend server 110 to enable the features, functionality, characteristics and/or the like as described herein. To this end, the processor 112 is operably connected to the memory 114 and the network communications module 116. The processor 112 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 112 may include a system with a central processing unit, graphics processing units, multiple processing units, dedicated circuitry for achieving functionality, programmable logic, or other processing systems.

The memory 114 is configured to store program instructions that, when executed by the processor 112, enable the backend server 110 to perform various operations described herein. The memory 114 may be any type of device or combination of devices capable of storing information accessible by the processor 112, such as memory cards, ROM, RAM, hard drives, discs, flash memory, or any of various other computer-readable media recognized by those of ordinary skill in the art. The memory 114 stores an interactive knowledge visualization program 118, as well as prompt and rules libraries 120. The processor 112 executes program instructions of the interactive knowledge visualization program 118 to recommend natural language prompts to a user based on user inputs, using prompt templates of the prompt and rules libraries 120. Additionally, the processor 112 executes program instructions of the interactive knowledge visualization program 118 to generate knowledge graphs and visualizations of natural language responses provided by the LLM 150, using rulesets of the prompt and rules libraries 120.

The network communications module 116 may comprise one or more transceivers, modems, processors, memories, oscillators, antennas, or other hardware conventionally included in a communications module to enable communications with various other devices, at least including the client device 130. In particular, the network communications module 116 may include a local area network port that allows for communication with any of various local computers housed in the same or nearby facility. Generally, the backend server 110 communicates with remote computers over the Internet via a separate modem and/or router of the local area network. Alternatively, the network communications module 116 may further include a wide area network port that allows for communications over the Internet. In one embodiment, the network communications module 116 is equipped with a Wi-Fi transceiver or other wireless communications device. Accordingly, it will be appreciated that communications with the backend server 110 may occur via wired communications or via the wireless communications. Communications may be accomplished using any of various known communications protocols.

With continued reference to FIG. 1, the client device 130 (which may also be referred to herein as a “personal electronic device”) may be a desktop computer, a laptop, a smart phone, a tablet, or any similar device. The client device 130 includes, for example, a processor 132, a memory 134, at least one network communications module 136, and a display screen 138.

The processor 132 is configured to execute instructions to operate the client device 130 to enable the features, functionality, characteristics and/or the like as described herein. To this end, the processor 132 is operably connected to the memory 134, the network communications module 136, and the display screen 138. The processor 132 generally comprises one or more processors which may operate in parallel or otherwise in concert with one another. It will be recognized by those of ordinary skill in the art that a “processor” includes any hardware system, hardware mechanism or hardware component that processes data, signals, or other information. Accordingly, the processor 132 may include a system with a central processing unit, graphics processing units, multiple processing units, dedicated circuitry for achieving functionality, programmable logic, or other processing systems.

The memory 134 is configured to store data and program instructions that, when executed by the processor 132, enable the client device 130 to perform various operations described herein. The memory 134 may be any type of device capable of storing information accessible by the processor 132, such as a memory card, ROM, RAM, hard drives, discs, flash memory, or any of various other computer-readable media serving as data storage devices, as will be recognized by those of ordinary skill in the art.

The network communications module 136 may comprise one or more transceivers, modems, processors, memories, oscillators, antennas, or other hardware conventionally included in a communications module to enable communications with various other devices, at least including the backend server 110. Particularly, the network communications module 136 generally includes a Wi-Fi module configured to enable communication with a Wi-Fi network and/or Wi-Fi router (not shown). Additionally, the network communications module 136 may include a Bluetooth® module (not shown) configured to enable communication with the backend server 110. Finally, the network communications module 136 may include one or more cellular modems configured to communicate with wireless telephony networks.

The display screen 138 may comprise any of various known types of displays, such as LCD or OLED screens. In some embodiments, the display screen 138 may comprise touch screens configured to receive touch inputs from a user. Alternatively, or in addition, the client device 130 may include additional user interfaces, such as buttons, switches, a keyboard or other keypad, speakers, and a microphone.

### Methods for Interactive Visualization of LLM Design Knowledge

A variety of methods, workflows, and processes are described below for enabling the operations of the interactive knowledge visualization system 100. In these descriptions, statements that a method, workflow, processor, and/or system is performing some task or function refers to a controller or processor (e.g., the processor 112 of the backend server 110 or the processor 132 of the client device 130) executing programmed instructions (e.g., the interactive knowledge visualization program 118) stored in non-transitory computer readable storage media (e.g., the memory 114 of the backend server 110 or the memory 134 of the client device 130) operatively connected to the controller or processor to manipulate data or to operate one or more components in the interactive knowledge visualization system 100 to perform the task or function. Additionally, the steps of the methods may be performed in any feasible chronological order, regardless of the order shown in the figures or the order in which the steps are described.

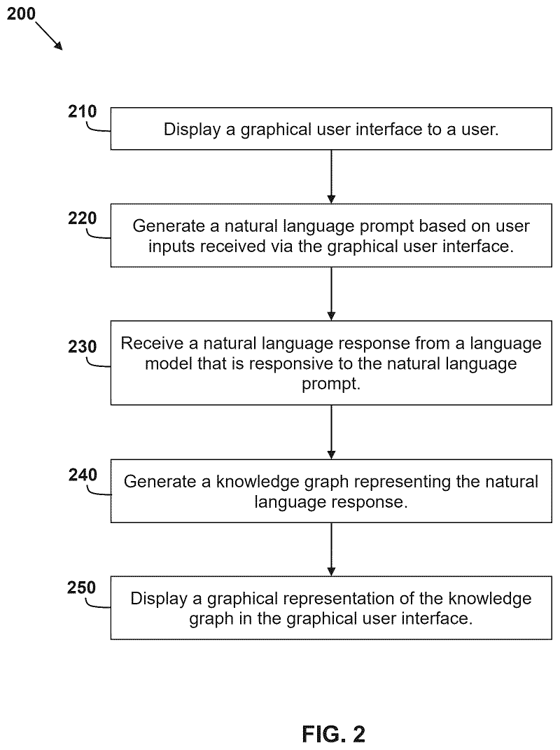

FIG. 2 shows a logical flow diagram for a method 200 for visualizing knowledge of an LLM using a knowledge graph. The method 200 advantageously organizes LLM responses into an interactive knowledge graph visualization. When applied to the task of design ideation, the interactive knowledge graph visualization helps to mitigate design fixation and enhances the overall efficiency, quality, quantity, and depth of concepts in the ideation process with the aid of this symbiotic human-LLM visual interface. Thus, the method 200 enhances overall efficiency and quality in the ideation process.

The method 200 begins with displaying a graphical user interface to a user (block 210). Particularly, the processor 132 of the client device 130 operates the display screen 138 to display a graphical user interface. The graphical user interface may be that of a native application on the client device 130 or a web-based interface displayed in an internet browser application on the client device 130. In the native application embodiment, the client device 130 executes the native application to render the graphical user interface on the display screen 138. In the web-based embodiment, the client device 130 receives elements of the graphical user interface via the network communications module 136 and renders the graphical user interface within an Internet browser application on the display screen 138. In one embodiment, the graphical user interface is implemented using Streamlit, a Python-based framework for deploying machine learning applications on the web.

The method 200 continues with generating a natural language prompt based on user inputs received via the graphical user interface (block 220). Particularly, the processor 112 of the backend server and/or the processor 132 of the client device 130 generates a natural language prompt based on user inputs received via the graphical user interface. Firstly, the processor 112 and/or the processor 132 receives a plurality of user inputs from the user via user interactions with the graphical user interface. The plurality of user inputs at least includes text inputs and a selected option from a plurality of predefined options. Next, the processor 112 and/or the processor 132 matches the selected option to a corresponding natural language prompt template from a plurality of natural language prompt templates stored in a prompt library (i.e., in the prompt and rules libraries 120). Finally, the processor 112 and/or the processor 132 generates the natural language prompt by incorporating the text inputs into slots of the natural language prompt template. The processor 132 operates the display screen 138 to display the generated natural language prompt to the user in the graphical user interface.

FIG. 4A shows an exemplary graphical user interface 400A of a sidebar menu for generating a natural language prompt. The processor 132 operates the display screen 138 to display the graphical user interface 400A. In the illustrated example, the interactive knowledge visualization system 100 is applied to the task of design ideation. The graphical user interface 400A includes a plurality of user-selectable options 402. Each of the user-selectable options 402 corresponds to a particular natural language prompt template in the prompt library. In the illustrated embodiment, the user-selectable options 402 relate to the problem of design ideation and are subdivided into two categories: “Design Activities” and “Design Methods.” The design activities include the user-selectable options 402: “Generate,” “Explore,” “Compare,” and “Critique.” Additionally, the design methods include the user-selectable options 402: “SCAMPER” (Substitute, Combine, Adjust, Modify, Put to other uses, Eliminate, Reverse), “Brainstorm,” and “Functional Decomposition.”

The graphical user interface 400A further includes one or more text fields 404 for populating a natural language prompt template. In at least some embodiments, each of the natural language prompt templates in the prompt library corresponds to a particular option from the plurality of user-selectable options 402. Accordingly, in some embodiments, the processor 112 and/or the processor 132 automatically updates the particular text fields 404 depending on the user-selectable option 402 that has been selected. In the illustrated example, the user has selected the “Generate” option and the text fields 404 include two text fields relating to the design goals of the “Generate” design activity: “Please enter your keyword concept:” and “Please enter the customer requirements.” In the first text field 404, the user types text defining a topic of the natural language prompt (e.g., “Outdoor Toy”) and, in the second text field 404, the user types text defining constraints on the natural language response (e.g., constraints on the design goal, “Mechanically Interactive” and “Safe”).

The graphical user interface 400A further includes a generated prompt text field 406. Once the user has selected one of the user-selectable options 402 and entered text into the text fields 404, the processor 112 and/or the processor 132 generates a suggested natural language prompt (e.g., “Can you list more ideas related to the concept of an Outdoor Toy that is Mechanically Interactive and Safe?”). The natural language prompt is displayed within the generated prompt text field 406. In at least some embodiments, the generated prompt text field 406 is a user-editable text field and the processor 132 receives edits from the user via the graphical user interface 400A, thereby defining an edited natural language prompt.

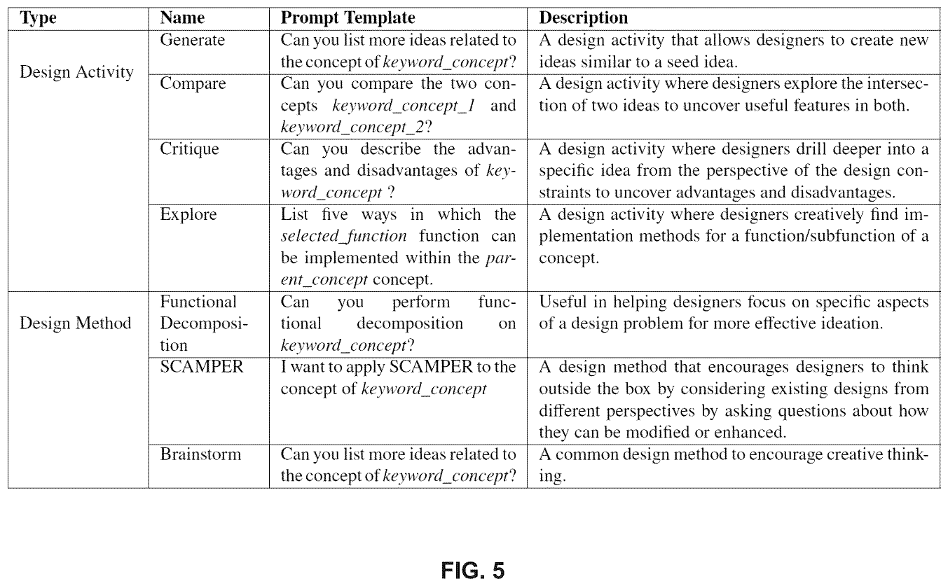

FIG. 5 summarizes exemplary natural language prompt templates for the task of design ideation. Each natural language prompt includes text with variable slots, which are filled based on the text inputs received from the user via the sidebar menu in the graphical user interface. Firstly, a “Generate” template allows designers to create new ideas similar to a seed idea. The “Generate” template includes the variable slot ‘keyword_concept’ that defines a topic of the generation. The variable slot ‘keyword_concept’ is populated by text inputs from the user, e.g., in the “Please enter your keyword concept:” text field 404 of FIG. 4A.

In at least some embodiments, natural language prompt templates include multiple variations (not shown) that are used depending on whether the user provides text inputs for the various text fields provided in the graphical user interface. Particularly, depending on whether certain text fields are left blank, the processor 112 and/or the processor 132 selects a different variation of the natural language prompt template corresponding to the selected option. For example, the “Generate” template includes a variation that incorporates the variable slot ‘requirements’ which define constraints on the natural language response. The variable slot ‘requirements’ is populated by further text inputs from the user, e.g., in the “Please enter the customer requirements” text field 404 of FIG. 4A. For example, the variation may take the form “Can you list more ideas related to the concept of keyword_concept that is requirements?” An exemplary natural language prompt generated using this variation is seen in the generated prompt text field 406 of FIG. 4A.

With continued reference to FIG. 5, the “Compare” template enables designers to explore the intersection of two ideas to uncover useful features in both. The “Compare” template includes the variable slots ‘keyword_concept_1’ and the variable slot ‘keyword_concept_2’ which define the topics of the comparison for the natural language prompt, and which are populated by text inputs from the user.

The “Critique” template enables designers to drill deeper into a specific idea from the perspective of the design constraints to uncover advantages and disadvantages. The “Critique” template includes the variable slot ‘keyword_concept’ that defines the topic of critique, and which is populated by text inputs from the user.

The “Explore” template enables designers to creatively find implementation methods for a function/subfunction of a concept. The “Explore” template includes the variable slots ‘selected_function’ and ‘parent_concept’ that define the topic of exploration, and which are populated by text inputs from the user.

The “Functional Decomposition” template enables designers to focus on specific aspects of a design problem for more effective ideation. The “Functional Decomposition” template at least includes the variable slot ‘keyword_concept’ that defines the topic of the functional decomposition, and which is populated by text inputs from the user.

The “SCAMPER” template enables designers to apply the SCAMPER method, which encourages designers to think outside the box by considering existing designs from different perspectives by asking questions about how they can be modified or enhanced. The “SCAMPER” template includes the variable slot ‘keyword_concept’ that defines the topic of the SCAMPER method, and which is populated by text inputs from the user.

Finally, the “Brainstorm” template enables designers to think creatively by brainstorming further ideas. The “Brainstorm” template includes the variable slot ‘keyword_concept’ that defines the topic of the brainstorming, and which is populated by text inputs from the user.

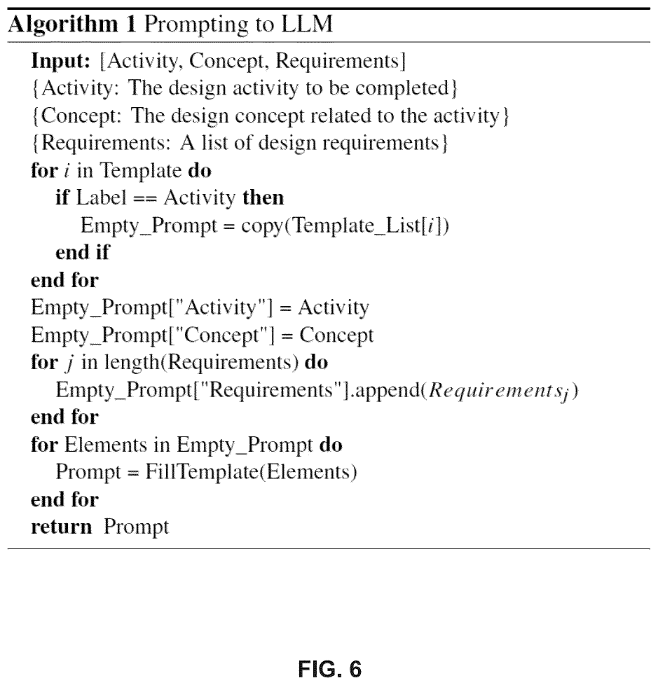

FIG. 6 shows pseudocode for generating a natural language prompt for an LLM. In the illustrated example, the processor 112 and/or the processor 132 generates a natural language prompt using a natural language prompt template having two variable slots ‘keyword_concept’ and ‘requirements,’ such as the “Generate” template. In summary, the processor 112 and/or the processor 132 receives the selected option (i.e., Activity) and the text inputs (i.e., Concept and Requirements). Next, the processor 112 and/or the processor 132 matches the selected option (i.e., Activity) to the correct natural language prompt template and instantiates a list (i.e., Empty_Prompt) based on the natural language prompt template that includes blank entries for each variable slot in the natural language prompt template. Next, the processor 112 and/or the processor 132 populates the list (i.e., Empty_Prompt) with the inputs (i.e., Activity, Concept, and Requirements). Since the ‘Requirements’ text inputs may include multiple terms or phrases, the processor 112 and/or the processor 132 appends each of the multiple terms or phrases to the list (i.e., Empty_Prompt). Finally, the processor 112 and/or the processor 132 fills the variable slots in the natural language prompt template and returns the natural language prompt.

Returning to FIG. 2, the method 200 continues with receiving a natural language response from a language model that is responsive to the natural language prompt (block 230). Particularly, the processor 112 of the backend server and/or the processor 132 of the client device 130 provides the generated, and optionally edited, natural language prompt to a language model for processing. Based on the natural language prompt, the processor 112 and/or the processor 132 receives a natural language response from the language model that is responsive to the provided natural language prompt. With reference again to FIG. 4A, the graphical user interface 400A includes a generate button 408. Once the user is satisfied with the natural language prompt, the user presses the generate button 408 provide a confirmation the that the natural language prompt has been finalized. In response to the confirmation, the processor 112 and/or the processor 132 to provides the natural language prompt to the LLM 150 and receives the natural language response.

The language model is a machine learning-based model, for example in the form of an artificial neural network. The language model is configured to receive natural language text as an input prompt and generate natural language text as an output response. In at least some embodiments, the language model is a large language model (LLM) 150, such as OpenAI's ChatGPT™, Google's Gemini™, or Anthropic's Claude™. An LLM is a generative machine learning model that is trained on vast amounts of textual data to understand and generate human-like responses to natural language prompts. These models are designed to predict and produce coherent and contextually relevant text, imitating human language fluency. They work by analyzing patterns in language data, learning grammar, context, and meaning, and then using that knowledge to generate new content.

In general, the LLM 150 is implemented by a remote third-party server rather than being executed directly by the client device 130 or by the backend server 110. Instead, the interactive knowledge visualization system 100 interfaces with the LLM 150 via Internet communications using an API. Particularly, once the natural language prompt is finalized, the processor 112 operates the network communications module 116 and/or the processor 132 operates the network communications module 136 to transmit a message including the natural language prompt to a server hosting the LLM 150. In response, the processor 112 receives via the network communications module 116 and/or the processor 132 receives via the network communications module 136 a natural language response from the LLM 150 that includes text that is responsive to the natural language prompt. However, in alternative embodiments, the backend server 110 and/or the client device 130 stores the LLM 150 and executes the LLM 150 to generate the natural language response locally.

In at least some embodiments, the processor 112 and/or the processor 132 is configured to incorporate additional language to the generated natural language prompt prior to providing it to the LLM 150, for the purpose of prompt engineering. For example, the natural language prompt may be modified to incorporate the additional language: “Please generate the response as a list of key concepts, each including a corresponding description.” This additional language is hidden from the user (i.e., not displayed in the generated prompt text field 406) but is designed to instruct the LLM 150 to generate the natural language response in a particular structured format. In some embodiments, the particular structured format and the additional language included in the natural language prompt is different depending on the natural language prompt template that was used. As will be discussed below, the particular structured format will be parsed to extract information from the natural language response for the purpose of generating a knowledge graph.

In at least some embodiments, the backend server 110 and/or the client device 130, or the LLM 150 itself, implements a LangChain algorithm to preserve the memory and context of the discussion with the LLM 150. The LangChain algorithm streamlines interactions with the LLM 150 by allowing for more complex, multi-step tasks. The LangChain algorithm connects different components such as memory, data retrieval, and APIs, enabling the LLM 150 to work with structured workflows of the interactive knowledge visualization system 100.

The method 200 continues with generating a knowledge graph representing the natural language response (block 240). Particularly, the processor 112 of the backend server and/or the processor 132 of the client device 130 generates a knowledge graph representing the natural language response received from the LLM 150. As used herein, a “knowledge graph” refers to any structured representation of information that organizes data into nodes (entities) and edges (relationships) to capture relationships between concepts in the information. Thus, the processor 112 and/or the processor 132 generates the knowledge graph including a plurality of nodes and a plurality of edges that connect respective pairs of nodes in the plurality of nodes.

To generate the knowledge graph, the processor 112 and/or the processor 132 extracts a plurality of keywords from the natural language response and defines respective nodes of the knowledge graph for each keyword. Additionally, the processor 112 and/or the processor 132 extracts a respective keyword description for each respective keyword from the natural language response and associates the respective keyword description with the corresponding node in the knowledge graph. As discussed above, in some embodiments, the natural language prompt incorporates additional text that instructs the LLM 150 to generate the natural language response in a particular structured format. In such embodiments, the processor 112 and/or the processor 132 extracts the keywords and keyword descriptions by parsing the particular structured format of the natural language response according to a predefined ruleset selected from a plurality of predefined rulesets in a ruleset library (i.e., in the prompt and rules libraries 120). In some embodiments, the processor 112 and/or the processor 132 uses a different predefined ruleset depending on the particular natural language prompt template that was used to generate the natural language prompt. In this way, the keywords and keyword descriptions can be easily extracted from the natural language response. In alternative embodiments, the processor 112 and/or the processor 132 may utilize a machine learning-based keyword and keyword description extraction technique.

In some embodiments, the processor 112 and/or the processor 132 defines a central node of the knowledge graph for a user-provided keyword from the first natural language prompt (e.g., the text input “Outdoor Toys” in the example of FIG. 4A). Next, the processor 112 and/or the processor 132 defines a respective edge in the knowledge graph connecting the central node to each of the nodes defined for the extracted keywords in the natural language response.

In some embodiments, the processor 112 and/or the processor 132 classifies each node of the knowledge graph as a respective node type from a plurality of node types (e.g., “Concept” nodes, “Information” nodes, and “Example” nodes). As discussed in greater detail below, each node of the knowledge graph is displayed in a visually distinctive manner that identifies the node type. In some embodiments, the processor 112 and/or the processor 132 classifies each node of the knowledge graph depending on the natural language prompt template that was used to generate the natural language prompt from which the natural language response was generated. For example, if the natural language response was generated based on a “Generate” prompt, then the nodes defined based on keywords in the natural language response are classified as “Concept” nodes. As another example, if the natural language response was generated based on an “Explore” prompt, then the nodes defined based on keywords in the natural language response are classified as “Example” nodes. As a final example, if the natural language response was generated based on a “Compare” prompt or “Critique” prompt, then the nodes defined based on keywords in the natural language response are classified as “Information” nodes.

In some embodiments, the processor 112 and/or the processor 132 retrieves a representative image for each keyword and associates the representative image with the corresponding node in the knowledge graph. Particularly, for each node in the knowledge graph, the processor 112 and/or the processor 132 retrieves a representative image using the image search platform 160, e.g., Bing image search or Google image search. The image search may be performed based on the keyword and/or the keyword description associated with the respective node. Once a representative image is retrieved, the processor 112 and/or the processor 132 associates the representative image with the respective node in the knowledge graph.

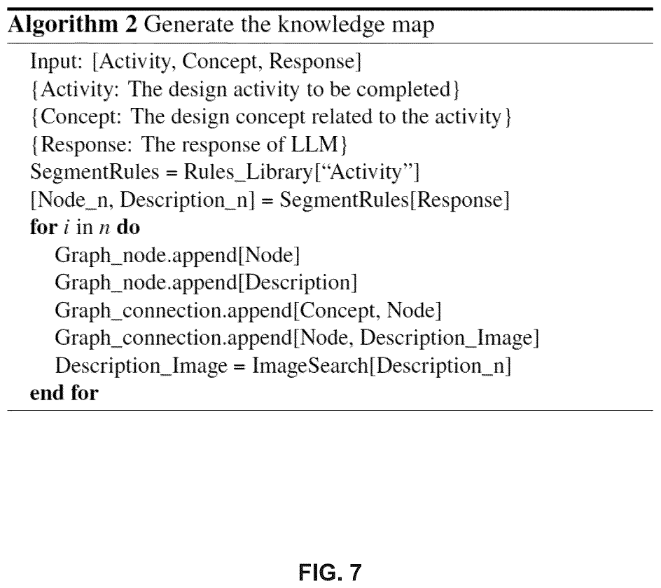

FIG. 7 shows pseudocode for generating a knowledge graph based on a natural language response from an LLM. In summary, the processor 112 and/or the processor 132 receives the selected option (i.e., Activity), the text inputs (i.e., Concept), and the natural language response from the LLM 150 (i.e., Response). Next, the processor 112 and/or the processor 132 matches the selected option (i.e., Activity) to the correct ruleset (i.e., SegmentRules) for parsing the natural language response. Next, the processor 112 and/or the processor 132 extracts n keywords (i.e., Node_n) of the knowledge graph, with n descriptions (i.e., Description_n), by parsing the natural language response using the ruleset (i.e., SegmentRules). For each of the n keywords, the processor 112 and/or the processor 132 adds the keyword and keyword description as a respective node (i.e., Graph_node.append) to the knowledge graph. Additionally, for each of the n keywords, the processor 112 and/or the processor 132 adds a respective edge (i.e., Graph_connection.append) to the knowledge graph that connects the keyword node to a central concept node, and associates a representative image (i.e., Description_Image) with the keyword node. The representative image (i.e., Description_Image) is retrieved using the image search platform 160 (i.e., ImageSearch[ ]).

Returning to FIG. 2, the method 200 continues with displaying a graphical representation of the knowledge graph in the graphical user interface (block 250). Particularly, the processor 112 and/or the processor 132 generates a graphical representation of the knowledge graph. The processor 132 of the client device 130 operates the display screen 138 to display the graphical representation of the knowledge graph in the graphical user interface.

The knowledge graph can be visualized in a wide variety of ways. In at least one embodiment, the processor 112 and/or the processor 132 generates the visualization of the knowledge graph as a node-link diagram, in which entities are represented as nodes and relationships are represented as edges connecting the nodes in a web-like manner. In another embodiment, the processor 112 and/or the processor 132 generates the visualization of the knowledge graph as a hierarchical tree that helps to visualize parent-child relationships between nodes of the knowledge graph. Such hierarchical trees can be flattened into a hierarchical linear list for easy viewing and navigation by simply scrolling up and down through the hierarchical linear list. In another embodiment, the processor 112 and/or the processor 132 generates the visualization of the knowledge graph as an adjacency list and/or an adjacency matrix, which displays relationships between entities in a grid-like format, offering a more compact representation of the knowledge graph. It should be appreciated that these are only a few of the wide variety of techniques that might be used to visualize the knowledge graph.

FIG. 4B shows an exemplary visualization 410 of a knowledge graph which is incorporated into the graphical user interface of the interactive knowledge visualization system 100. The processor 132 operates the display screen 138 to display the visualization 410 in the graphical user interface, in particular within a knowledge graph canvas of the graphical user interface. The visualization 410 is in the form of a node-link diagram having a plurality of nodes represented by circles and a plurality of edges represented by lines linking the circles to one another, which is generated using, for example, the Agraph Library. The plurality of nodes includes a central node 420 representing the user-provided keyword (e.g., “Outdoor Toys”) that was used to generate the natural language prompt. The plurality of nodes further includes concept nodes 422A-F. The concept nodes 422A-F are nodes of the “Concept” node type and include concepts/keywords extracted from the natural language response (e.g., “Flying toys,” “Nature exploration kits,” “Water toys,” “Construction toys,” “Musical instruments,” and “Gardening tools”). Each of the concept nodes 422A-F is connected by an edge to the central node. The concept nodes 422A-F were, for example, populated on the basis of a natural language prompt using the “Generate” template with respect to the “Outdoor Toys” keyword concept, as illustrated in FIG. 4A.

In the illustrated embodiment, each node 420, 422A-F in the knowledge graph is displayed in association with the previously retrieved representative image associated with the node. Particularly, in one embodiment, to make it easier for the user to quickly understand what each node represents, the processor 112 and/or the processor 132 renders each of the nodes 420, 422A-F with the representative image depicted within the circle and with a text label beneath the circle.

In addition to the graphical depiction of the knowledge graph, the graphical user interface of the interactive knowledge visualization system 100 further enables the user to directly explore the text of the natural language response provided by the LLM 150. To this end, the processor 132 operates the display screen 138 to display one or more previously received natural language responses from the LLM 150 in the graphical user interface. Additionally, the processor 132 operates the display screen 138 to display one or more previously provided user inputs that were used to generate previously generated natural language prompts.

FIG. 4C shows a further exemplary graphical user interface 400B of the sidebar menu for exploring the natural language prompts and responses of the LLM 150. The processor 132 operates the display screen 138 to display the graphical user interface 400B. The graphical user interface 400B includes design gallery window 430, which includes a list of keyword concepts that have been input by the user and used to generate natural language prompts, a list of selected nodes in the knowledge graph, and a list of nodes that have been explored by the user. To manage the extensive number of nodes within the knowledge graph, the user can manually flag and place the node of interest into the design gallery window 430. Users can directly select nodes of the knowledge graph by clicking the node or edges in the graphical representation of the knowledge graph that is displayed in the graphical user interface. Additionally, the graphical user interface 400B includes design history window 432 which displays one or more previously received natural language responses from the LLM 150. In the illustrated example, the design history window 432 displays the natural language response received in response to the natural language prompt of FIG. 4A.

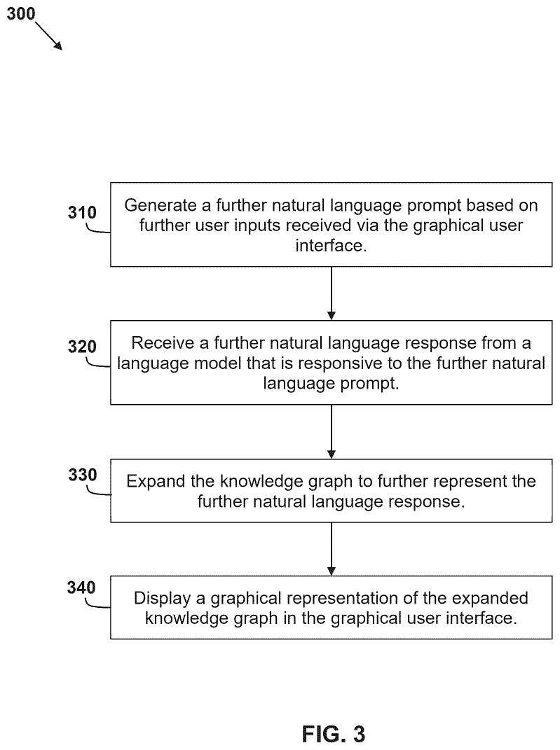

FIG. 3 shows a logical flow diagram for a method 300 for interactively expanding the knowledge graph to include further knowledge of the LLM 150. The method 300 advantageously enables the user to interactively expand a knowledge graph by further prompting the LLM 150 to provide additional responses that include additional knowledge.

The method 300 begins with generating a further natural language prompt based on further user inputs received via the graphical user interface (block 310). Particularly, the interactive knowledge visualization system 100 enables users to expand the knowledge graph to include additional information extracted from further natural language responses with respect to particular nodes in the knowledge graph. To this end, the processor 112 of the backend server and/or the processor 132 of the client device 130 generates a further natural language prompt based on further user inputs received via the graphical user interface.

In an essentially similar manner as discussed above, the processor 112 and/or the processor 132 receives a plurality of user inputs from the user via user interactions with the graphical user interface. The plurality of user inputs includes a selected option from a plurality of predefined options. However, in contrast to generating the initial natural language prompt, the plurality of user inputs also includes a selection of a selected node from the plurality of nodes of the knowledge graph. Next, the processor 112 and/or the processor 132 matches the selected option to a corresponding natural language prompt template from a plurality of natural language prompt templates stored in the prompt library (i.e., in the prompt and rules libraries 120). Finally, the processor 112 and/or the processor 132 generates the natural language prompt by incorporating the keyword and/or keyword description associated with the selected node into the natural language prompt template. The processor 132 operates the display screen 138 to display the generated natural language prompt to the user in a graphical user interface.

FIG. 4D shows an exemplary graphical user interface 400C of an interaction menu for interacting with nodes of the knowledge graph and generating further natural language prompts. The processor 132 operates the display screen 138 to display the graphical user interface 400A. The graphical user interface 400C includes a visualization 440 of a knowledge graph in the form of a node-link diagram, which is similar to the visualization 410 of FIG. 4B except that the knowledge graph has not yet been expanded.

Upon the user selection of a node in the visualization 440, an interaction menu 450 will display on the right side of the graphical user interface 400C. The interaction menu 450 includes a drop-down menu 452 from which the user can select from a plurality of user-selectable options. Several of the user-selectable options in the drop-down menu 452 correspond to particular natural language prompt template in the prompt library. In some embodiments, the drop-down menu 452 also includes additional options for managing the knowledge graph, such as options for deleting nodes, deleting edges, manually connecting nodes, or annotating/marking nodes. In the illustrated example, the concept node 422F in the visualization 440 (i.e., “Gardening tools”) was selected by the user and the user has selected the “Explore” option from the drop-down menu 452. Additionally, the interaction menu 450 includes a keyword description 454 associated with the selected node.

After the user has selected a node and selected an option from the drop-down menu 452, the processor 112 and/or the processor 132 matches the selected option to a corresponding natural language prompt template from the prompt library. The processor 112 and/or the processor 132 generates the natural language prompt by incorporating the keyword and/or keyword description associated with the selected node into the natural language prompt template. The processor 132 operates the display screen 138 to display the generated natural language prompt to the user within the generated prompt text field 406 of the sidebar menu of FIG. 4A, from which it can be edited.

It should be appreciated that, in some embodiments, a different variation of the natural language prompt template may be used for prompts generated using interaction menu 450 compared to the initial prompt generation using the sidebar menu of FIG. 4A. Additionally, in some cases, the selected option the drop-down menu 452 supports incorporating additional user inputs via the one or more text fields 404 of the sidebar menu of FIG. 4A, in a similar manner as discussed previously. In this way, multiple variations of each natural language prompt template may be used depending on whether the user provides additional text inputs.

The method 300 continues with receiving a further natural language response from a language model that is responsive to the further natural language prompt (block 320). Particularly, in an essentially similar manner that was discussed previously with respect to block 230 of the method 200, the processor 112 of the backend server and/or the processor 132 of the client device 130 provides the generated, and optionally edited, natural language prompt to the LLM 150 for processing. Based on the natural language prompt, the processor 112 and/or the processor 132 receives a natural language response from the language model that is responsive to the provided natural language prompt. With reference again to FIG. 4D, the graphical user interface 400C includes a generate button 456. Once the user is satisfied with the natural language prompt, the user presses the generate button 456 to provide the natural language prompt to the LLM 150 and receive the natural language response.

The method 300 continues with expanding the knowledge graph to further represent the further natural language response (block 330). Particularly, the processor 112 of the backend server and/or the processor 132 of the client device 130 expands the knowledge graph to further represent the further natural language response received from the LLM 150. Specifically, the processor 112 and/or the processor 132 expands the knowledge graph by adding additional nodes and/or additional edges to the knowledge graph based on the further natural language response.

In an essentially similar manner as was discussed with respect to block 240 of the method 200, to expand the knowledge graph, the processor 112 and/or the processor 132 extracts a plurality of keywords from the further natural language response and defines respective nodes of the knowledge graph for each keyword. Additionally, the processor 112 and/or the processor 132 extracts a respective keyword description for each respective keyword from the further natural language response and associates the respective keyword description with the corresponding node in the knowledge graph.

In some embodiments, the processor 112 and/or the processor 132 defines a respective edge in the knowledge graph connecting each of the newly added nodes for the keywords in the further natural language response to the previously selected node in the knowledge graph that was used to generate the further natural language prompt. For example, in the illustrated example of FIG. 4D, in which the user selected the “Gardening Tools” node 422F, the processor 112 and/or the processor 132 defines edges connected the “Gardening Tools” node 422F to each new node generated on the basis of the further natural language response.

In some embodiments, the processor 112 and/or the processor 132 classifies each new node of the knowledge graph as a respective node type from a plurality of node types (e.g., “Concept” nodes, “Information” nodes, and “Example” nodes) depending on the natural language prompt template that was used to generate the natural language prompt from which the natural language response was generated. For example, in the illustrated example of FIG. 4D, in which the “Explore” prompt template was used, the nodes defined based on keywords in the further natural language response are classified as “Example” nodes.

The method 300 continues with displaying a graphical representation of the expanded knowledge graph in the graphical user interface (block 340). Particularly, the processor 112 and/or the processor 132 generates a graphical representation of the expanded knowledge graph. The processor 132 of the client device 130 operates the display screen 138 to display the graphical representation of the expanded knowledge graph in the graphical user interface.

With reference again to FIG. 4B, the visualization 410 incorporates the results of multiple expansions of the original knowledge graph including the concept nodes 422A-F relating to the “Generate” prompt with respect to “Outdoor Toys.” Particularly, after the initial generation of the knowledge graph, the LLM 150 was further prompted to provide examples with respect to the “Gardening tools” concept node 422F using the “Explore” prompt. The knowledge graph was subsequently expanded based on the natural language response to the “Explore” prompt. As a result of this expansion, the plurality of nodes further includes example nodes 424A-F. The example nodes 424A-F are nodes of the “Example” node type and include examples/keywords extracted from the natural language response (e.g., “Pruning shears,” “Watering can,” “Rake,” “Garden gloves,” “Hand trowel,” and “Garden fork”). Each of the example nodes 424A-F are connected by edges to the “Gardening tools” concept node 422F that was selected to generate the “Explore” prompt.

In a similar manner, the LLM 150 was further prompted to perform functional decomposition with respect to the “Gardening gloves” example node 424D using the “Functional Decomposition” prompt. The knowledge graph was subsequently expanded based on the natural language response to the “Functional Decomposition” prompt. As a result of this expansion, the plurality of nodes further includes information nodes 426A-E. The information nodes 426A-E are nodes of the “Information” node type and include information/keywords extracted from the natural language response (e.g., “Safety,” “Versatility,” “Ergonomics,” “Compatibility,” and “Accessibility”). Each of the information nodes 426A-E are connected by edges to the “Gardening gloves” example node 424D that was selected to generate the “Functional Decomposition” prompt.

In the illustrated embodiment, each node 420, 422A-F, 424A-F, 426A-E in the knowledge graph is displayed in a visually distinctive manner that identifies a node type (e.g., “Concept” nodes, “Information” nodes, and “Example” nodes). Particularly, in one embodiment, the processor 112 and/or the processor 132 displays the concept nodes 422A-F with a first color (e.g., red), displays the example nodes with a second color 424A-F (e.g., blue), and displays the information nodes 426A-E with a third color (e.g., green).

In the illustrated embodiment, each node 420, 422A-F, 424A-F, 426A-E in the knowledge graph is displayed in association with the previously retrieved representative image associated with the node. Particularly, in one embodiment, to make it easier for the user to quickly understand what each node represents, the processor 112 and/or the processor 132 renders each of the nodes 420, 422A-F, 424A-F, 426A-E with the representative image depicted within the circle and with a text label beneath the circle.

### Exemplary Use Cases

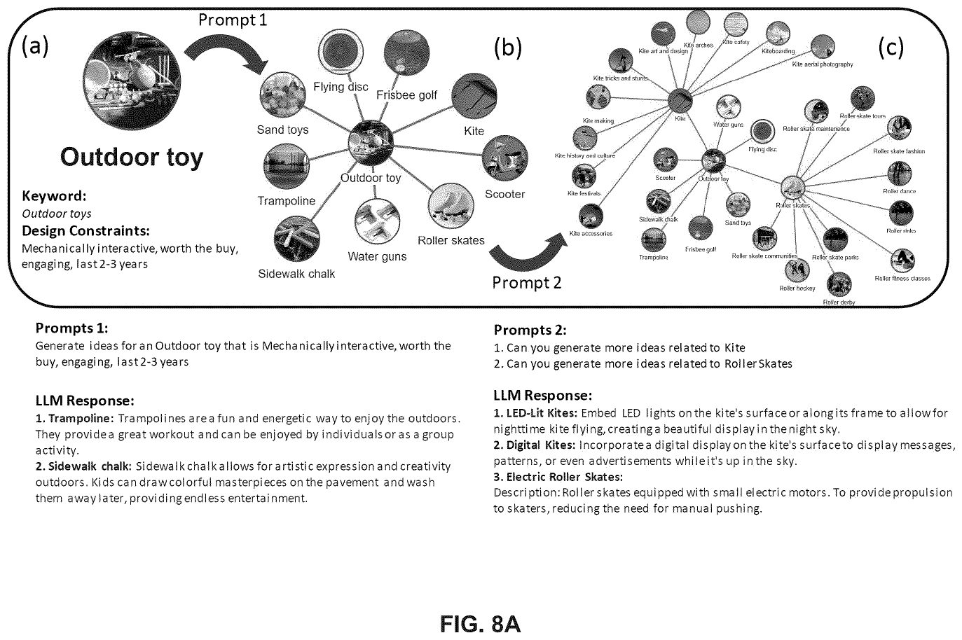

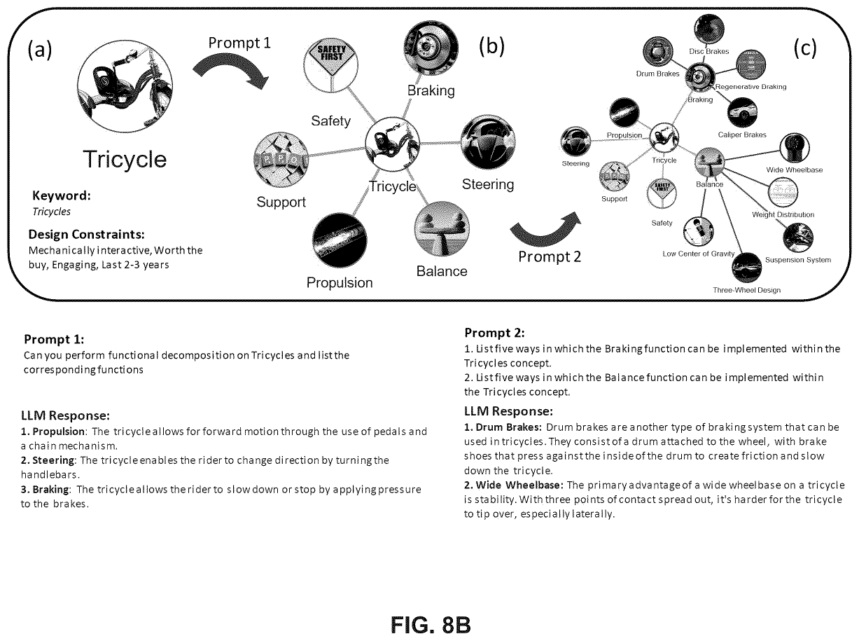

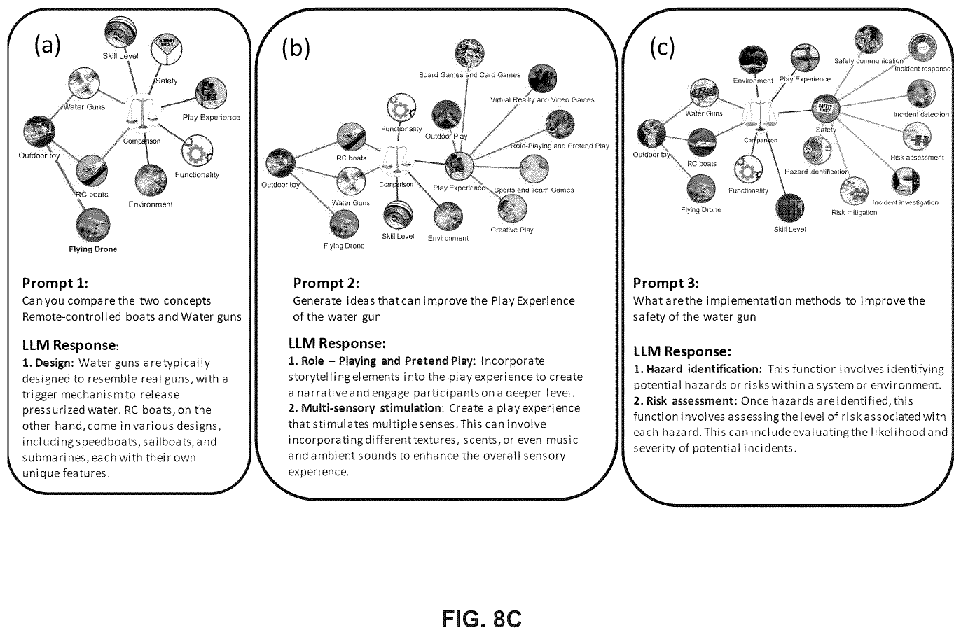

FIG. 8A illustrates a first exemplary use case in which a user generates design concepts and visualizes them structurally. The process unfolds as follows: First, the user starts with a seed concept (i.e. “Outdoor Toys”). Next, the interactive knowledge visualization system 100 generates and visualizes additional design concepts related to the seed concept. Finally, the user continues to explore the design space by prompting the LLM and receiving responses.

Design ideation begins with the generation of new design concepts. Typically, a designer is provided with a usage scenario for the target design, along with specific design constraints that outline customer requirements such as safety, cost, and recommended age grading. The interactive knowledge visualization system 100 aids the designer in thinking outside the box and developing distinct perspectives on the given problem to identify needs and features.

Through visual interactions and automatic knowledge graph expansion, users can seamlessly organize ideas and track iterations of their concepts without interrupting their creative flow. For instance, in illustration (1) of FIG. 8A, a user wishes to brainstorm ideas for the design of an outdoor toy. Given this design task, the user inputs keywords and requirements into the interactive knowledge visualization system 100, such as “Outdoor toys,” “Mechanically Interactive,” and “Worth the buy.”

Subsequently, the user prompts the LLM 150 using suggested prompts, as depicted in illustration (2) of FIG. 8A. Upon prompting, the system receives responses from the LLM 150 and utilizes the keywords from those responses to visualize concepts and generate a design knowledge graph. The user can continue generating ideas based on the original design goal or explore concepts similar to those generated, as shown in illustration (3) of FIG. 8A. In this use case, the user opts to explore ideas related to kites and roller skates, allowing the system to structure a large number of concepts in a manner that effectively tracks the user's ideation flow.

FIG. 8B illustrates a second exemplary use case in which the user explores a functional decomposition of a concept. The process unfolds as follows: First, the user creates a concept node. Next, they then use the interactive knowledge visualization system 100 to perform a design method, in this case, functional decomposition, to retrieve design knowledge related to the concept. Finally, further refinement of the concept is achieved by the user exploring alternative ways to implement two functions: braking and balance.

In some situations, designers are required to refine an existing design to enhance its performance or adapt it to different application contexts. To do this effectively, the designer must acquire knowledge about the various features of the design and understand their limitations. An example of this process is illustrated in FIG. 8B, where the designer is tasked with improving the play value of a tricycle. The designer first manually creates a node on the knowledge graph canvas, as shown in illustration (1) of FIG. 8B. Next, they perform a functional decomposition using prompts suggested by the system, as depicted in illustration (2) of FIG. 8B. For each function, the designer can explore potential ways to implement it in the existing design, thereby refining it, as shown in illustration (3) of FIG. 8B.

FIG. 8C illustrates a third exemplary use case in which a user compares two design concepts. The process unfolds as follows: First, the user compares two design concepts. Next, the user generates new concepts based on one aspect of the comparison. Finally, the user refines the concepts based on this refinement.

Comparing design concepts is an efficient way to build knowledge about the problem and stimulate human creativity for novel ideas. The interactive knowledge visualization system 100 empowers designers with knowledge from LLMs to comprehensively and efficiently compare design concepts from distinct perspectives. In illustration (1) of FIG. 8C, the designer wants to compare two concepts: RC boats and water guns. Assuming they have already acquired design knowledge about features, functions, and implementations for each concept from two distinct knowledge graphs, the interactive knowledge visualization system 100 can perform an engineering comparison of the concepts.

As shown in illustration (2) of FIG. 8C, the aspects of comparison include functionality, skill level, play experience, environment, and safety. The user directly selects the nodes within the knowledge graph and applies the comparison operation through the interface. The responses are added to the knowledge graph as new nodes. Once the comparison is performed, the designer can select different nodes and generate ideas based on them or explore ways to implement them in their design, as depicted in illustration (3) of FIG. 8C. Here, the designer generates ideas to improve the play experience of the water gun and brainstorms ways to enhance its safety. All these operations are conducted simply through click actions, and the system curates prompts that the designer can choose from, using the customer requirements and information stored in the clicked node and its parent nodes.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for visualizing natural language responses of a language model, the method comprising:
displaying, on a display, a graphical user interface;
generating, with a processor, a first natural language prompt based on first user inputs received via the graphical user interface;
receiving, with the processor, a first natural language response from the language model that is responsive to the first natural language prompt;
generating, with the processor, a knowledge graph representing the first natural language response; and
displaying, on the display, a graphical representation of the knowledge graph in the graphical user interface.

2. The method according to claim 1, the generating the first natural language prompt further comprising:
receiving, as the first user inputs, text inputs and a first selected option from a plurality of predefined options via the graphical user interface;
matching the first selected option to a first natural language prompt template from a plurality of natural language prompt templates; and
generating the first natural language prompt by incorporating the text inputs into the first natural language prompt template.

3. The method according to claim 2, wherein the text inputs include (i) first text inputs defining a topic of the first natural language prompt and (ii) second text inputs defining constraints on the first natural language response.

4. The method according to claim 2, wherein each of the plurality of natural language prompt templates corresponds to a particular option from the plurality of predefined options.

5. The method according to claim 1 further comprising:
displaying the first natural language prompt in the graphical user interface; and
providing the first natural language prompt to the language model in response to receiving a confirmation from the user via the graphical user interface.

6. The method according to claim 5, the displaying the first natural language prompt further comprising:
displaying the first natural language prompt in a user-editable text field of the graphical user interface; and
receiving edits from the user defining an edited first natural language prompt via the graphical user interface,
wherein the edited first natural language prompt is provided to the language model in response to the confirmation.

7. The method according to claim 1, the receiving the first natural language response further comprising:
transmitting the first natural language prompt to a remote server that hosts the language model; and
receiving the first natural language response from the remote server.

8. The method according to claim 1, wherein the knowledge graph has a plurality of nodes and a plurality of edges that connect respective pairs of nodes in the plurality of nodes, the generating the knowledge graph further comprising:
extracting a first plurality of keywords from the first natural language response; and
defining a respective node the plurality of nodes of the knowledge graph for each keyword in the first plurality of keywords.

9. The method according to claim 8, the generating the knowledge graph further comprising:
defining a central node of the plurality of nodes of the knowledge graph for a user-provided keyword from the first natural language prompt; and
defining a respective edge in the plurality of edges of the knowledge graph connecting the respective node defined for each keyword in the first plurality of keywords to the central node.

10. The method according to claim 8, the generating the knowledge graph further comprising:
extracting, for each respective keyword in the first plurality of keywords, a respective keyword description from the first natural language response; and
associating, for each respective keyword in the first plurality of keywords, the respective keyword description with the respective node in the knowledge graph defined for the respective keyword.

11. The method according to claim 8, the generating the first natural language prompt further comprising:
incorporating, into the first natural language prompt, natural language text instructing the language model to generate the first natural language response in a particular structured format,
wherein the first plurality of keywords are extracted from the first natural language response by parsing the particular structured format of the first natural language response.

12. The method according to claim 8, the generating the knowledge graph further comprising:
classifying each node in the plurality of nodes of the knowledge graph as a respective node type from a plurality of node types,
wherein each node in the plurality of nodes of the knowledge graph is displayed in a visually distinctive manner that identifies the respective node type.

13. The method according to claim 12, the classifying each node in the plurality of nodes of the knowledge graph further comprising:
classifying each node in the plurality of nodes of the knowledge graph depending on a respective natural language prompt template from a plurality of natural language prompt templates that was used to generate the first natural language prompt.

14. The method according to claim 8, the generating the knowledge graph further comprising:
retrieving, for each respective keyword in the first plurality of keywords, a respective representative image of the respective keyword,
wherein each respective node in the plurality of nodes of the knowledge graph is displayed in association with the representative image of the respective keyword for which the respective node was defined.

15. The method according to claim 1 further comprising:
generating, with the processor, a second natural language prompt based on second user inputs received via the graphical user interface;
receiving, with the processor, a second natural language response from the language model that is responsive to the second natural language prompt;
expanding, with the processor, the knowledge graph to further represent the second natural language response; and
displaying, on the display, a graphical representation of the expanded knowledge graph in the graphical user interface.

16. The method according to claim 15, wherein the knowledge graph has a plurality of nodes and a plurality of edges that connect respective pairs of nodes in the plurality of nodes, the generating the second natural language prompt further comprising:
receiving, as the second user inputs, a selection of a selected node from the plurality of nodes of the knowledge graph and second selected option from a plurality of predefined options via the graphical user interface;
matching the second selected option to a second natural language prompt template from a plurality of natural language prompt templates; and
generating the second natural language prompt by incorporating a keyword associated with the selected node into the second natural language prompt template.

17. The method according to claim 16, the expanding the knowledge graph further comprising:
extracting a second plurality of keywords from the second natural language response; and
adding a respective node to the plurality of nodes of the knowledge graph for each keyword in the second plurality of keywords.

18. The method according to claim 17, the expanding the knowledge graph further comprising:
adding a respective edge in the plurality of edges of the knowledge graph connecting the respective node defined for each keyword in the second plurality of keywords to the selected node.

19. The method according to claim 1 further comprising:
displaying, on the display, a plurality of previously received natural language responses from the language model in the graphical user interface.

20. The method according to claim 1 further comprising:
displaying, on the display, a plurality of previously provided user inputs that were used to generate a plurality of previously generated natural language prompts.
